(19) United States
(12) Patent Application Publication
(10) Pub. No.: US 2003/0147360 A1
(43) Pub. Date: Aug. 7, 2003

(54) Automated wellbore apparatus

(76) Inventors: Michael Nero, Houston, TX (US); Clemens L. Horst, Houston, TX (US); Hatem M. Salem Morsy, The Woodlands, TX (US)

Correspondence Address: WILLIAM B. PATTERSON, MOSER, PATTERSON & SHERIDAN, L.L.P., Suite 1500, 3040 Post Oak Blvd., Houston, TX, 77056, US

(21) Appl. No.: 10/068,555

(22) Filed: Feb. 6, 2002

(51) Int. Cl. H04Q 7/00

(52) U.S. Cl. 370/314

(57) ABSTRACT

Methods, apparatus and articles of manufacture are provided for a configurable downhole tool. The downhole tool includes a plurality of devices each of which is configured for one or more functions. At some point during operation (e.g., during system initialization), the presence of each device disposed on the downhole tool is detected. Each device may then begin performing its respective function or functions. For example, some devices may be configured to collect environmental data while the tool is disposed in a wellbore. In one embodiment, the collected data is provided to a transceiver. The transceiver then transmits the data from the downhole tool to some remove receiving unit, which may be located at the surface of the wellbore.

### BACKGROUND OF THE INVENTION

1. Field of the Invention

The present invention generally relates to drilling tools and system for use with the same.

2. Description of the Related Art

To obtain hydrocarbons such as oil and gas, boreholes or wellbores are drilled by rotating a drill bit attached to the bottom of a drilling assembly. The drilling assembly is attached to the bottom of a tubing, which is usually either a jointed rigid pipe or a relatively flexible spoolable tubing commonly referred to in the art as “coiled tubing.” The string comprising the tubing and the drilling assembly is usually referred to as the “drill string.” When jointed pipe is utilized as the tubing, the drill bit is rotated by rotating the jointed pipe from the surface and/or by a mud motor contained in the drilling assembly. In the case of a coiled tubing, the drill bit is rotated by the mud motor. During drilling, a drilling fluid (also referred to as the “mud”) is supplied under pressure into the tubing. The drilling fluid passes through the drilling assembly and then discharges at the drill bit bottom. The drilling fluid provides lubrication to the drill bit and carries to the surface rock pieces disintegrated by the drill bit in drilling the wellbore. The mud motor is rotated by the drilling fluid passing through the drilling assembly. A drive shaft connected to the motor and the drill bit rotates the drill bit.

The success of hydrocarbon production directly depends on the availability of meaningful data before, during and after the well construction process, which process includes the drilling of the wellbore. In particular, data pertaining to the subterranean environment (i.e., the borehole) is needed. Such data typically includes temperature, pressure, gamma radiation, electrical resistivity and the like. Known tools for acquiring such data include measurement-while-drilling (MWD), logging while drilling (LWD), and temperature/pressure/flow measurement tools during drilling and wireline tools after the wellbores have been drilled. Transmission of data acquired by such tools may be performed by telemetry devices disposed on the tool. Such telemetry devices include mud-pulse devices, acoustic devices and electromagnetic devices. Communication of data between the surface and the downhole tools may also be facilitated by transmitting the data through the wall of the drill string or a conductor within a “built for purpose drill string”. Such built for purpose drill strings are described in U.S. Pat. Nos. 2,379,800, 3,696,332, 4,095,865, 4,445,734, 2,414,719, 3,090,031, 4,605,268, 4,788,544, 4,806,928, 4,901,069 and those patents are incorporated by reference herein in their entirety.

In addition to acquiring data from the subterranean environment, it is necessary to communicate to the surface information pertaining to the tool itself. For example, directional drilling requires knowing the position of the tool from time to time in order ensure a proper orientation and direction of the tool. Directional drilling involves drilling of deviated and horizontal wellbores to more fully exploit hydrocarbon reservoirs. To this end, downhole tools may be equipped with gyroscopes, accelerometers, magnetometers and other devices known in the art used to determine the orientation of the tool. The information collected by such devices must then be transmitted to the surface for analysis. Once the orientation/direction of the tool has been ascertained, control signal are transmitted downhole to the tool and, more specifically, to a plurality of independently operable force application members to apply force on the wellbore wall during drilling of the wellbore to maintain the drill bit along a prescribed path or to alter the drilling direction.

Further, it is desirable to monitor the operation of the downhole tool itself. For example, the strain on a motor or vibration of a drill bit may be observed to ensure operation within acceptable margins.

In addition to monitoring the downhole environment as well as the downhole tool, it is necessary to control the operation of the downhole tool. As noted above, for example, the tool must be steered along a desired path and toward a desired destination by issuing control signals to steering devices on board the tool. Other aspects of a downhole tool which must be controlled include adjustment of downhole stabilizers, modification of variable diameter bits and underreamers, adjustable drilling jars and generally the external or internal configuration or state of operation of the downhole tool.

Accordingly, a variety of techniques are utilized for monitoring reservoir conditions, estimation and quantities of hydrocarbons in earth formations, for formation determination and wellbore parameters, for determining the operating or physical conditions of downhole tools and for controlling components of a downhole tool. However, each of these techniques requires specialized equipment which must be customized for the particular application at hand. No universally adaptable tool exists which is capable of being easily tailored for any variety of applications. In particular, adding and removing the various powered devices typically disposed on a downhole tool requires substantial overhead in terms of integration and configuration of the devices. Accordingly, exploration and production of hydrocarbons is time-consuming and expensive.

Therefore, there is a need for a downhole tool adaptable to a variety of applications and environments.

### SUMMARY OF THE INVENTION

The present invention generally provides for systems, methods and articles of manufacture for configuring a downhole tool, which may be modular.

One embodiment provides a method for configuring and communicating between a server node and a plurality of secondary nodes disposed on a modular downhole tool. The method comprises a) detecting, by the server node, the presence of each secondary node; and b) at least one of: i) requesting information from at least one of the plurality of secondary nodes; and ii) issuing a control signal to at least one of the plurality of secondary nodes. In one embodiment, the server node is disposed on a first module of the modular downhole tool and wherein at least one of the plurality of secondary nodes is disposed on a second module of the modular downhole tool; and wherein the first and second modules are releasably coupled to one another.

Another embodiment provides a signal bearing medium containing a program which, when executed by a server node, performs an operation for configuring and communicating between a server node and a plurality of secondary nodes disposed on a modular downhole tool. Illustratively, the operation comprises a) detecting, by the server node, the presence of each secondary node; and b) at least one of: i) requesting information from at least one of the plurality of secondary nodes; and ii) issuing a control signal to at least one of the plurality of secondary nodes.

Yet another embodiment provides a downhole communications system, comprising: a server node, comprising a transceiver configured to communicate with a plurality of secondary nodes and a controller connected to the transceiver and configured to perform an operation. Illustratively, the operation comprises detecting the presence of the plurality of secondary nodes and at least one of: a) requesting, via the transceiver, information from at least one of the plurality of secondary nodes; and b) issuing, via the transceiver, a control signal to at least one of the plurality of secondary nodes.

Still another embodiment provides a downhole tool, comprising at least one secondary downhole tool module equipped with at least a secondary node; and a server downhole tool module releasably connected to the least one secondary downhole tool module and equipped with at least a server node communicably connected to the secondary node. The server node is configured perform an operation comprising detecting the presence of the secondary node; and at least one of i) requesting information from the secondary node; and ii) issuing a control signal to the secondary node.

### BRIEF DESCRIPTION OF THE DRAWINGS

So that the manner in which the above recited features, advantages and objects of the present invention are attained and can be understood in detail, a more particular description of the invention, briefly summarized above, may be had by reference to the embodiments thereof which are illustrated in the appended drawings.

It is to be noted, however, that the appended drawings illustrate only typical embodiments of this invention and are therefore not to be considered limiting of its scope, for the invention may admit to other equally effective embodiments.

FIG. 1 is a one embodiment of a modular downhole tool 100.

FIG. 2 is an exemplary configuration of the downhole tool shown in FIG.

FIG. 3 is an embodiment of a communication system comprising a plurality of nodes, each configured with measurement devices;

FIG. 4 is a representation of a remote frame;

FIG. 5 is a representation of a data frame;

FIG. 6 is communications environment illustrating the operation of the communication system shown in FIG. 3;

FIGS. 7A and 7B illustrate the jar in a retracted and extended position with a data wire disposed in an interior thereof;

FIGS. 8A and 8B are section views of a jar having an inductive connection means between the jar housing and a central mandrel; and

FIG. 9 is a section view of a jar having electromagnetic subs disposed at each end thereof.

### DETAILED DESCRIPTION OF THE PREFERRED EMBODIMENT

The present invention generally provides for a configurable downhole tool. The downhole tool includes a plurality of devices each of which is configured for one or more functions. At some point during operation (e.g., during system initialization), the presence of each device disposed on the downhole tool is detected. Each device may then begin performing its respective function or functions. For example, some devices may be configured to collect environmental data while the tool is disposed in a wellbore. In one embodiment, the collected data is provided to a transceiver. The transceiver then transmits the data from the downhole tool to some remove receiving unit, which may be located at the surface of the wellbore.

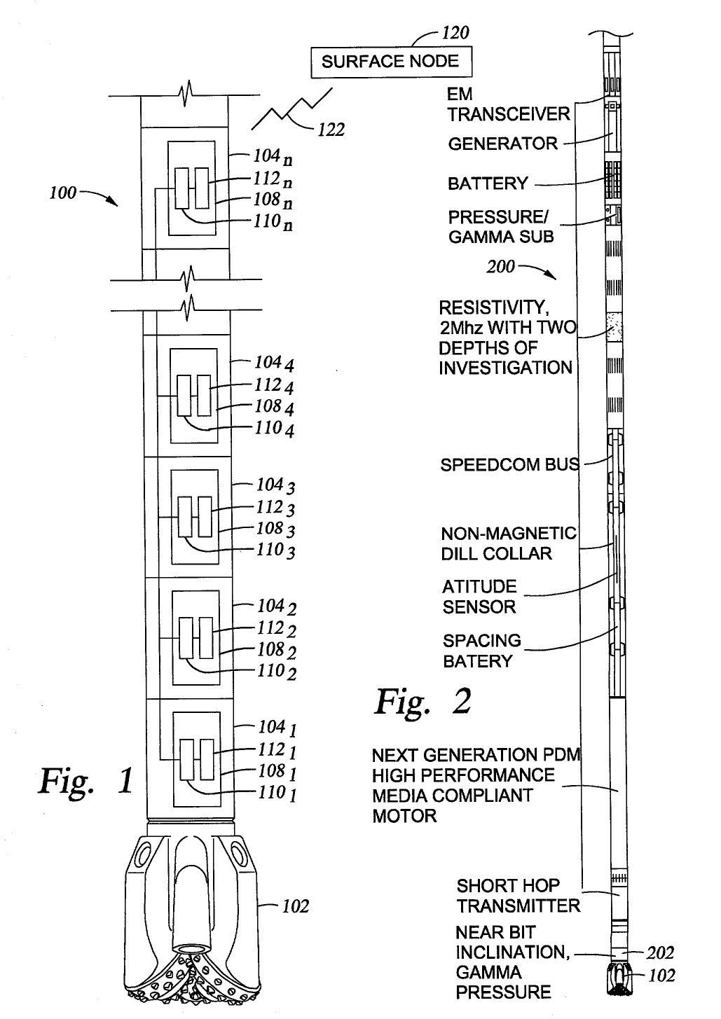

FIG. 1 shows one embodiment of a modular downhole tool 100. Illustratively, the downhole tool 100 is a drilling tool and, as such, carries a drill bit at a terminal end. However, more generally, the downhole tool 100 may be any tool configured for subterranean applications. As such, the downhole tool 100 may be a measurement while drilling (MWD) tool, logging while drilling (LWD) tool, a logging tool, a pumping tool, pressure while drilling measurement tool.

The tool 100 is equipped with a plurality of nodes 108₁, 108₂, . . . 108_{N} (collectively, nodes 108) each communicably connected to a bus 106. In one embodiment, each node 108 includes a communications facility 110₁, 110₂, . . . 110_{N} (collectively, communications facilities 110) and a device 112₁, 112₂, . . . 112_{N} (collectively, devices 112). The communications facilities 110 may be any device or devices capable of transmitting and receiving information via a bus 106. Each device 112 may in fact be a plurality of devices, circuits and other components cooperating to perform a specific function. For example, some devices 112 may be configured to collect environmental data while the tool 100 is disposed in a wellbore. Examples of environmental data include resistivity, pressure, gamma radiation, etc. In other embodiments, the devices 112 may be configured to collect information pertaining to the tool 100 itself. For example, the devices 112 may include accelerometers and magnetometers. In still other embodiments, the devices 112 may be configured to control operational aspects of the tool 100, such as steering.

In operation, the nodes 108 (using their respective communications facility 110) receive and transmit information via the bus 106. The term “bus” is used herein to represent any transmission medium capable of propagating control and/or data signals between the devices disposed on the tool 100 and/or between devices disposed on the tool 100 and devices located elsewhere (e.g., on the surface). In a particular embodiment, the bus 106 is a CAN bus, as will be described in detail below. As such, the bus 106 may be a physical transmission line. However, in another embodiment, the nodes 108 communicate by wireless means.

In one embodiment, the tool 100 is made up of a plurality of modules 104₁, 104₂, . . . 104_{N} (collectively, modules 104). A module is defined herein as a discrete component capable of being releasably connected to other components which make up a downhole tool. Releasably connected means any non-permanent connection which facilitates a relatively easy and expeditious detachment.

Each module 104 shown in FIG. 1 is shown equipped with one of the nodes 108. As such, a given module 104 may be defined by the devices 112 located thereon. However, it is understood that each module 104 may include more that one node 108 and more than one type of device 112. For example, a module 104 may include pressure measuring devices and gamma radiation measuring devices.

In one embodiment, a module 104 of the downhole tool 100 comprises a thruster. A thruster is typically disposed above a drill bit (e.g., drill bit 102) in a drilling string and is particularly useful in developing axial force in a downward direction when it becomes difficult to successfully apply force from the surface of the well. For example, in highly deviated wells, the trajectory of the wellbore can result in a reduction of axial force placed on the drill bit. Installing a thruster near the drill bit can solve the problem. A thruster is a telescopic tool which includes a fluid actuated piston sleeve. The piston sleeve can be extended outwards and in doing so can supply needed axial force to an adjacent drill bit. When the force has been utilized by the drill bit, the drill string is moved downwards in the wellbore and the sleeve is retracted. Thereafter, the sleeve can be re-extended to provide an additional amount of axial force. Various other devices operated by hydraulics or mechanical can also be utilized to generate supplemental force and can make use of the invention.

Conventional thrusters are simply fluid powered and have no means for operating in an automated fashion. However, with the ability to transmit data back and forth along a drill string, the thrusters can be automated and can include sensors (also communicably linked to the bus 106) to provide information to an operator about the exact location of the extendable sleeve within the body of the thruster, the amount of resistance created by the drill bit as it is urged into the earth and even fluid pressure generated in the body of the thruster as it is actuated. Additionally, using valving in the thruster mechanism, the thruster can be operated in the most efficient manner depending upon the characteristics of the wellbore being formed. For instance, if a lesser amount of axial force is needed, the valving of the thruster can be adjusted in an automated fashion from the surface of the well to provide only that amount of force required. Also, an electric on-board motor powered from the surface of the well could operate the thruster thus, eliminating the need for fluid power. With an electrically controlled thruster, the entire component could be switched to an off position and taken out of use when not needed.

Yet another component used to facilitate drilling, and configurable as a module 104 in one embodiment of the downhole tool 100, is a drilling hammer. Drilling hammers typically operate with a stoke of several feet and jar a pipe and drill bit into the earth. By connecting drill hammer control devices to the bus 106, the operation of the drill hammer may be controlled while downhole and, therefore, its use could be tailored to particular wellbore and formation conditions.

In another embodiment, a module 104 of the tool 100 comprises a stabilizer. A stabilizer is typically disposed in a drill string and, like a centralizer, includes at least three outwardly extending fin members which serve to center the drill string in the borehole and provide a bearing surface to the string. Stabilizers are especially important in directional drilling because they retain the drill string in a coaxial position with respect to the borehole and assist in directing a drill bit at a desired angle. Furthermore, the gage relationship between the borehole and stabilizing elements can be monitored and controlled. The fin members of the stabilizer could be automated to extend or retract individually in order to more exactly position the drill string in the wellbore. By using a combination of sensors and actuation components, the stabilizer could become an interactive part of a drilling system and be operated in an automated fashion.

In another embodiment, a module 104 of the tool 100 comprises a vibrator. The vibrator may be disposed near the drill bit 102 and operate to change the mode of vibration created by the bit to a vibration that is not resonant. By removing the resonance from the bit, damage to other downhole components can be avoided. By connecting the vibrator to the bus 106, the vibrator's operation can be controlled and its own vibratory characteristics can be changed as needed based upon the vibration characteristics of the drill bit 102. By monitoring vibration of the bit from the surface of the well, the vibration of the vibrator can be adjusted to take full advantage to its ability to affect the mode of vibration in the wellbore.

In a variety of downhole applications, it is necessary to transmit information between the downhole tool 100 and some other remote device. In particular, communications between the downhole tool 100 and the surface are often necessary or desirable. For example, information about the downhole environment (e.g., pressure, gamma radiation, temperature, resistivity) is often transmitted to a surface receiver for analysis. As such, in one embodiment, one of the modules may be equipped a communications device (i.e., one of the devices 112) configured for transmitting data collected by one or more of the other devices 112 to a remote location. In one embodiment, such a communications device is one of a current dipole telemetry device and a magnetic dipole telemetry device. In another embodiment, the communications device includes both a current dipole telemetry device and a magnetic dipole telemetry device. One such device is described in European Patent Application EP 0987402 A2, entitled “Drill String Telemetry”, filed on Sep. 15, 1999, and assigned to Cryoton, Limited, of Singleton Park, Swansea, Great Britain, and incorporated by reference herein in its entirety.

Other communications techniques which may be used to advantage according to aspects of the present invention include wired assemblies wherein a conductor capable of transmitting information connects components in a drill string to the surface of the well and to each other. The advantage of these “wired pipe” arrangements is a higher capacity for passing information in a shorter time than what is available, for example, with a mud pulse system. For example, early prototype wired arrangements have carried 28,000 bits of information per second.

FIG. 2 shows an embodiment of a downhole tool 200, which is representative of an exemplary configuration of the downhole tool 100. As such, like numerals are used to identify components described above with reference to FIG. 1. In general, the downhole tool 200 comprises a plurality of devices communicably connected to the bus 106. Each of the devices may be considered part of a node, either alone or in combination with other devices. Illustratively, the tool 200 is equipped with any number of detection, measurement and monitoring devices proximate the drill bit 102 and referred to herein as “near bit” devices 202. Illustratively, such near bit devices 202 may be configured for determining inclination, gamma radiation, pressure and the like. The near bit devices 202 are advantageously positioned proximate the drill bit 102 in order to collect the most meaningful information, i.e., information obtained from the environment immediately proximate the drill bit.

In other instances, sensors may be placed on the drill bit 102 itself to monitor variables at the drilling location like vibration, temperature and pressure. By measuring the vibration and the amplitude associated with it, the information cold be transmitted to the surface and the drilling conditions adjusted or changed to reduce the risk of damage to the bit and other components due to resonate frequencies. In other examples, specialized drill bits with radially extending members for use in under-reaming could be controlled much more efficiently through the use of information transmitted through the bus 106.

Again, the embodiment of the downhole tool 200 shown in FIG. 2 is merely illustrative and it is understood that the invention facilitates any configuration of devices on a downhole tool. In particular, aspects of the invention facilitate the expeditious attachment and removal of devices without impacting the overall system operation and without requiring substantial human intervention to configure the network of devices on-board a downhole tool. As such, in one aspect, the downhole tool is auto-configuring because the devices need only be connected to the bus 106 in order to be operational (i.e., send and receive information). Further, the devices are not limited to particular types of devices, thereby allowing for a comprehensive network of any variety of devices.

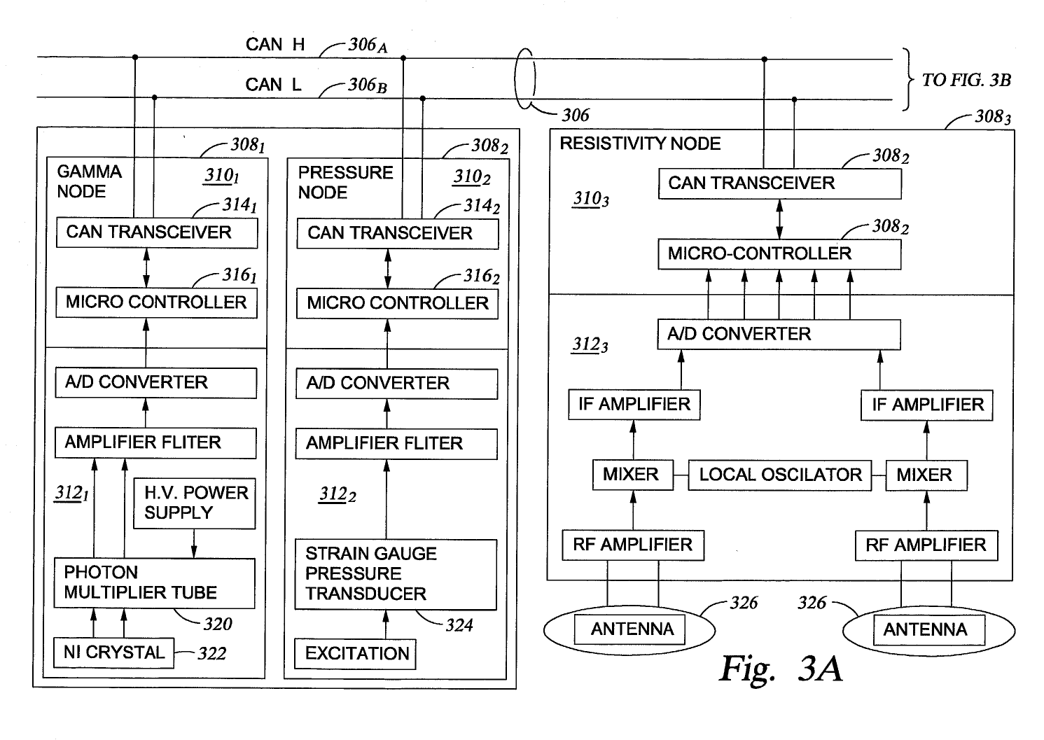

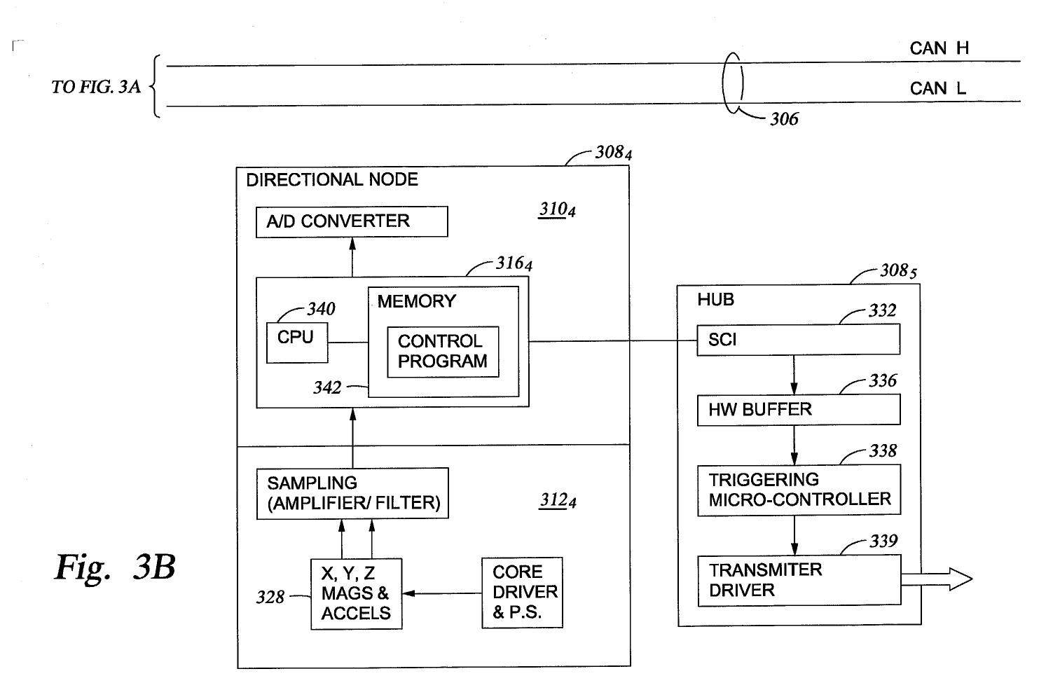

One embodiment of a particular network of devices which may be disposed on a downhole tool is shown in FIG. 3 as system 300. In general, the system 300 is configured with five nodes 308₁, 308₂ 308₃, 308₄, and 308₅ (collectively, nodes 308) each of which is connected to a bus 306 via a communications/operations facility 310₁, 310₂, 310₃, 310₄, and 310₅ (collectively, communications facilities 310). Four of the nodes 308₁, 308₂, 308₃ and 308₄ are configured to collect data either from the environment of the tool (on which the system resides) or pertaining to the tool itself. Illustratively, the system 300 includes a gamma node 308₁, a pressure node 308₂, a resistivity node 308₃, and a directional node 308₄.

In one embodiment, each of the nodes may be located on a different module. In an alternative embodiment, two or more nodes are located on the same module. For example, in one embodiment, the gamma radiation node and the pressure node are located on a common module. This may be advantageous because pressure and gamma measurements are typically performed in combination with each other.

Each of the respective nodes includes the appropriate measurement devices 312₁, 312₂, 312₃ and 312₄ (collectively, measurement devices 312). Accordingly, the gamma radiation node 308₁ includes a photon multiplier tube 320 and a NI crystal 322; the pressure node 308₂ includes a strain gauge pressure transducer 324; the resistivity node 308₃ includes RF antennas 326; and the directional node 308₄ includes altitude sensing equipment 328, which may include any combination of magnetometers and accelerometers. Each of the measurement devices 312 may also include any number of well-known components including amplifiers, filters mixers, A/D converters, excitation devices, oscillators, and the like.

In the particular embodiment illustrated by FIG. 3, the bus 306 is a CAN bus adapted for CAN protocol communications. The bus 306 includes a high signal path 306A and a low signal path 306B. Further, communication over the CAN bus 306 is performed by a CAN transceiver 314₁, 314₂, 314₃, 314₄ and 314₅ (collectively, transceivers 314) included with each of the communications facilities 310. The transceivers 314 are each communicably linked to a microcontroller 316₁, 316₂, 316₃, 316₄ and 316₅ (collectively, microcontrollers 316). In general, the microcontrollers 316 are configured to operate their respective nodes. In particular, the microcontroller's 316 transmit messages to and receive messages from the bus 306. Outbound messages may include data collected by the respective measurement devices 312 of the transmitting node. Incoming messages may include messages transmitted from any of the other nodes. However, as will be described in more detail below, each node receives only selected messages. Messages which are of no interest to a particular node are disregarded.

One of the nodes is configured as a “server” node responsible for coordinating the operation of the other nodes (e.g., requesting and receiving information from the other nodes). Illustratively, the directional node 308₄ is the server node. The server node is implemented as part of one of the nodes for the sake of efficiency and practicality. In particular, the server node is conveniently integrated with the directional node 308₄ because a directional node is typically present in drilling tools. However, in another embodiment, the server node may be a separate node. The microcontroller 316₄ of the server node 308₄ generally includes a central processing unit (CPU) 340 and a memory 342 connected by a bus 344. The central processing unit 340 may be any processor or combination of processors adapted to carry out the functions disclosed herein. The contents of the memory 342 can be accessed as processor has need for it. The memory 342 may be any memory device sufficiently large to hold the necessary programming and data structures of the invention. The memory 342 could be one or a combination of memory devices, including random access memory (RAM), non-volatile or backup memory such as programmable or flash memory or read-only memory (ROM). In an alternative embodiment, the memory 342 may be physically located in another part of the system 300. While the memory 342 is shown as a single entity, it should be understood that the memory may in fact comprise a plurality of modules, and that the memory may exist at multiple levels, from low speed memory devices to high speed memory devices, such as caches and registers.

Illustratively, the memory 342 is shown containing a control program 344. The control program 344 may be any set of routines which, when executed by the CPU 340, issues the appropriate control signals and transmits data to the various nodes of the system 300. It should be noted that, although not shown for purposes of simplicity, each of the other nodes may be similarly configured with a processor and a memory containing programming which, when executed by the processor, performs the communications described herein.

In operation, the server node 3084 requests and receives information from each of the other nodes. The received information is then provided to a transmission node, or hub 308₅. The hub 308₅ may include any combination of components capable of receiving information from the server, in this case the directional node 308₄. As such, the microcontroller 316₂ of the directional node 308₄ is connected to a serial connection interface (SCI) 332 of the hub 308₅ via a communications line 334. Information transported from the server node to the hub 308₅ may be temporarily stored in a buffer 336. A triggering microcontroller 338 then issues a signal to a transmitter 339 causing the transmitter to transmit the information contained in a buffer 336.

At boot up, the server node 308₄ issues a “wake up” message to the various nodes 308₁, 308₂ and 308₃ and then listens to the bus 306 for responses. Each of the nodes attached to the bus 306 responds with a message indicating that it is present and is available to start receiving requests for information. Such requests for information are sent from the server node in the form of remote frame requests. As is known in the art, the remote frame is indented to solicit the transmission of a corresponding data frame.

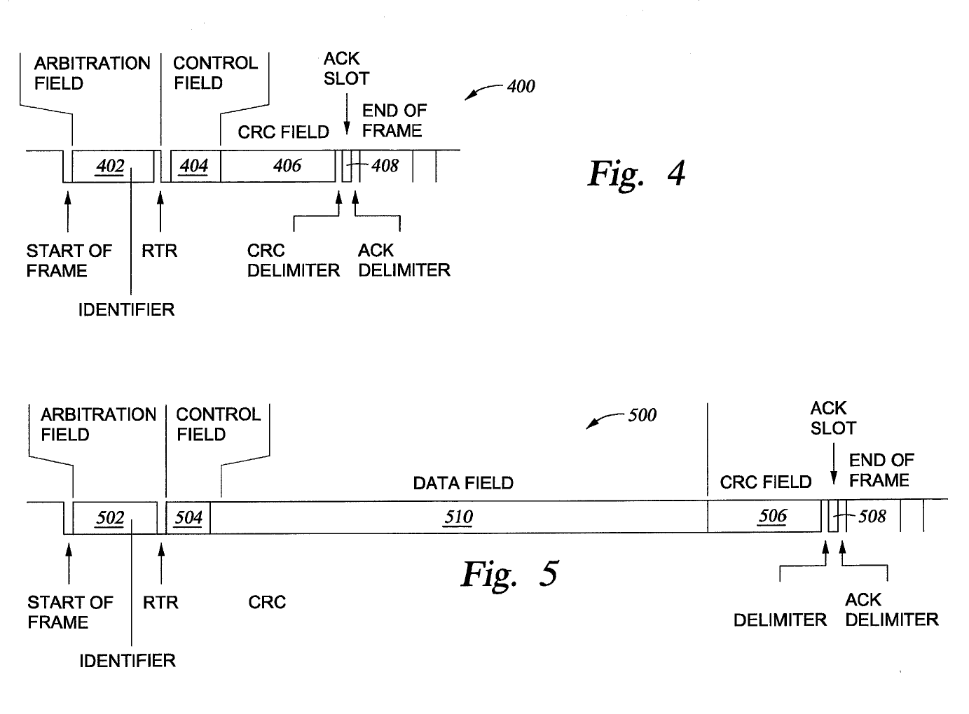

An illustrative remote frame and an illustrative data frame are shown in FIGS. 4 and 5, respectively. In general, the remote frame 400 and the data frame 500 both include an arbitration field 402, 502 a control field 404, 504 a cyclic redundancy check (CRC) field 406, 506 and an acknowledgment slot 408, 508. The data frame 500 also includes a data field 512 which contains the actual data, e.g., the data to be transmitted from the hub 308₅. The arbitration field 402, 502 contains an identifier specifying the origin of the frame and also contains information used by the nodes to determine whether the frame is if interested to them. As such, the CAN protocol is said to be content-based, rather than address-based. The arbitration field also includes an RTR bit used to determine the priority of a message when two or more nodes are contending for the bus. To this end, the RTR bit is either dominant or recessive. The control field 404, 504 contains information specifying the size of the frame. The CRC field 406, 506 contains a checksum calculated on most parts of the message. The checksum is then used for air detection. The acknowledgment slot 408, 508 contains an acknowledgment bit used by receiving nodes to acknowledge receipt of the message. After transmitting a message, the transmitting node checks for the presence of the acknowledgment bit and retransmits the message if no acknowledgment bit is detected.

Each of the nodes is configured to respond to a particular remote frame, according to the contents of the remote frame. Upon receipt of the appropriate remote frame, the receiving node responds with the corresponding data frame which contains data collected by the respective measurement devices of the receiving node. As with the remote frames, the nodes are able to identify data frames of interest according to their contents (i.e., the content of the identifier in the arbitration field). The server node may then transport the received data to the hub 308₅ for transmission therefrom.

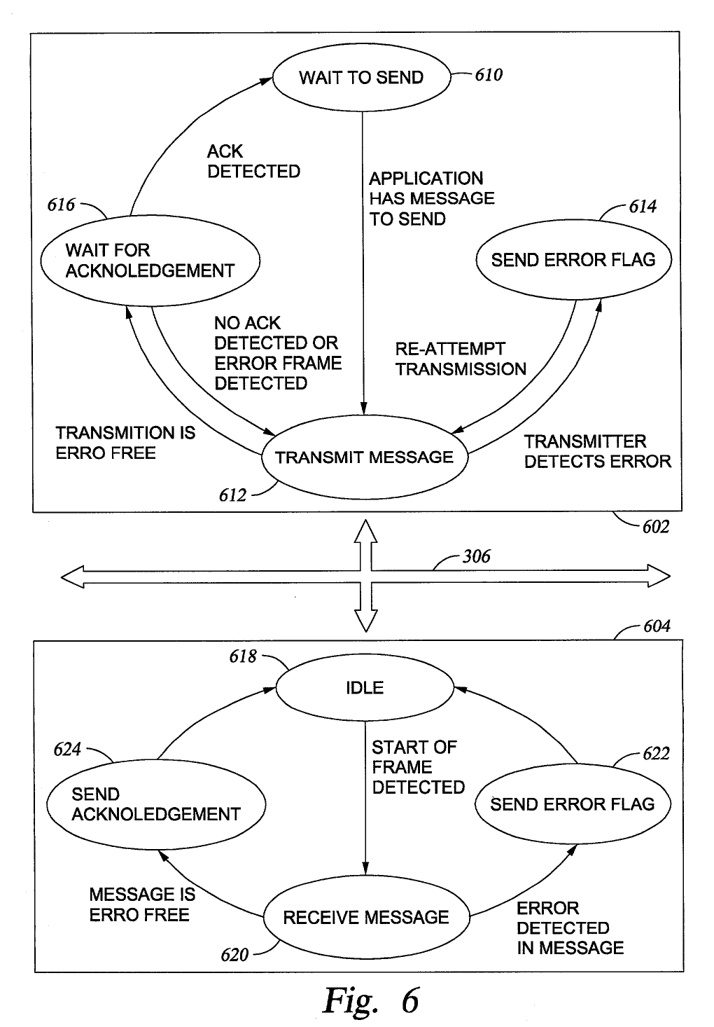

The operation of the system 300 using the CAN protocol may be further described with reference to FIG. 6. In general, FIG. 6 shows a transmitting node 602 and a receiving node 604 connected to a bus 306. The nodes 602 and 604 may be representative of any of the nodes 308₁, 308₂, 308₃, and 308₄ shown in FIG. 3. Initially, the transmitting 602 node waits to send a message (block 610). As noted above, the CAN protocol is implemented using dominant value messages and recessive value messages. If the message to be sent is dominant then the transmitting node takes control of the bus 306 and transmits the message (block 612). If the CAN controller detects an error in the transmission, the controller sends an error flag (block 614) and attempts to retransmit the message (block 612). Once the message is successfully transmitted without error, the transmitting node waits for an acknowledgment from any of the other nodes on the bus 306 (block 616). If no acknowledgment is detected within the prescribed time period, or if an error frame is detected, the message is retransmitted (block 612).

In contrast, the receiving node 604 is initially idle (block 618). The receiving node 604 begins receiving the message when the beginning of a frame is detected (block 620). The receiving node 604 then determines whether an error is detected in the message. If an error is detected, the receiving node 604 sends an error frame containing an error flag (block 622). Otherwise, if the message is error-free, the receiving node 604 sends an acknowledgment (block 624).

It should be noted that, at present, standard CAN (formally known as 2.0A) and extended CAN (formally known as 2.0B) exist. However, embodiments of the present invention are not limited to a particular format or standard, nor to any particular protocol. Accordingly, both standard CAN and extended CAN may be used to advantage.

In the foregoing embodiments, the nodes are connected by a physical transmission line, e.g., a bus. However, as stated above, wireless communications between the nodes is also contemplated. To this end, the transceivers 314 may be wireless transceivers such as Bluetooth, 802.11a, and 802.11b transceivers.

The foregoing embodiments are merely illustrative. The present invention admits of any system or method capable of supporting communications between a plurality of devices in a downhole tool. For example, in another embodiment, a downhole tool is equipped with a client-server system in which a server is configured to determine the presence of a plurality of clients. Each client is a software application adapted to perform a particular function or functions, such as any of the functions described above (e.g., pressure measuring, radiation measuring, resistivity measuring, steering, etc.). The client devices are capable of being coupled or decoupled to a transmission medium which facilitates communication between one another and with the server. In this manner, the clients may be selected and arranged according to a particular application and downhole environment. At initial program load (IPL) of the system, the server determines (e.g., detects) the presence of each of the client devices connected to the transmission medium. Additionally or alternatively, the clients may be dropped and added from the system after boot up. Particular techniques and protocols for detecting the presence of hardware on a system are well-known. The present invention employs these techniques and protocols to achieve advantages heretofore unknown in the context of downhole tools. Once the devices have been detected, they may be begin transmitting and receiving information.

As is evident from the foregoing, some embodiments of the invention may be implemented as software routines which execute to perform any of a variety of functions including those disclosed herein. The routines can be contained on a variety of signal-bearing media. Illustrative signal-bearing media include, but are not limited to: (i) information permanently stored on non-writable storage media (e.g., read-only memory devices within a computer such as CD-ROM disks readable by a CD-ROM drive); (ii) alterable information stored on writable storage media (e.g., floppy disks within a diskette drive or hard-disk drive); or (iii) information conveyed to a computer by a communications medium, such as through a computer or telephone network, including wireless communications. Such signal-bearing media, when carrying computer-readable instructions that direct the functions of the present invention, represent embodiments of the present invention.

In general, the routines executed to implement the embodiments of the invention, may be part of an operating system or a specific application, component, program, module, object, or sequence of instructions. The computer program(s) of the present invention typically is comprised of a multitude of instructions that will be translated by the native computer into a machine-readable format and hence executable instructions. Also, programs are comprised of variables and data structures that either reside locally to the program or are found in memory or on storage devices. In addition, various programs described hereinafter may be identified based upon the application for which they are implemented in a specific embodiment of the invention. However, it should be appreciated that any particular program nomenclature that follows is used merely for convenience, and thus the invention should not be limited to use solely in any specific application identified and/or implied by such nomenclature.

Accordingly, a downhole tool is provided which may be configured as a plurality of modules, each of which is equipped with one or more nodes. To facilitate such connections, apparatus are needed to couple the modules to one another as well as couple the nodes to one another. The invention is not limited by the particular manner in which modules and nodes are connected to one another. For example, in one embodiment, a five conductor wet connect is used to advantage to couple the modules to one another.

With regard to connectivity of the nodes, any variety of well known techniques may be employed. For example, the techniques for configuring a “wired pipe” may used to connect the nodes to one another. However, one limitation arising with the use of wired pipe is transferring signals between sequential joints of drill string. Accordingly, the invention contemplates any variety of techniques and apparatus, known and unknown, for transmission between components of the downhole tool itself (e.g., between the various nodes residing on different modules). For example, it is known to use couplings having an inductive means to transmit data to an adjacent component. Using this approach, an electrical coil is positioned near each end of each component. When two components are brought together, the coil in one end of the first is brought into close proximity with the coil in one end of the second. Thereafter, a carrier signal in the form of an alternating current in either segment produces a changing electromagnetic field, thereby transmitting the signal to the second segment. In another embodiment, sealing arrangements between tubulars provide a metal-to-metal conductive contact between the joints. In one such a system, for example, electrically conductive coils are positioned within ferrite troughs in each end of the tubulars. The coils are connected by a sheathed coaxial cable. When a varying current is applied to one coil, a varying magnetic field is produced and captured in the ferrite trough and includes a similar field in an adjacent trough of a connected pipe. The coupling field thus produced has sufficient energy to deliver an electrical signal along the coaxial cable to the next coil, across the next joint, and so on along multiple lengths of drill pipe. Amplifying electronics are provided in subs that are positioned periodically along the string in order to restore and boost the signal and send it to the surface or to subsurface sensors and other equipment as required. Using this type of wired pipe, signals may be propagated between components (e.g., devices and nodes) of the downhole tool.

Despite the foregoing approaches for transmitting data up and down a string of components (e.g., between the various nodes) using wired pipe, there are some components that are especially challenging for use with wired pipe. These include those components having relative motion between internal parts, especially axial and rotational motion resulting in a change in the overall length of the tool or a relative change in the position of the parts with respect to one another. For example, the relative motion between an inner mandrel and an outer housings of jars, slingers, and bumper subs can create a problem in signal transmission, especially when a conductor runs the length of the tool. This problem can apply to any type of tool that has inner and outer bodies that move relative to one another in an axial direction. Embodiments for overcoming the foregoing problems, and which may be used to advantage with aspects of the present invention, are described in U.S. patent application Ser. No. 09/976,845, entitled “Methods and Apparatus to Control Downhole Tools,” filed on Oct. 12, 2001 and assigned to Weatherford, Incorporated (herein referred to as the '845 application), which is incorporated by reference herein in its entirety.

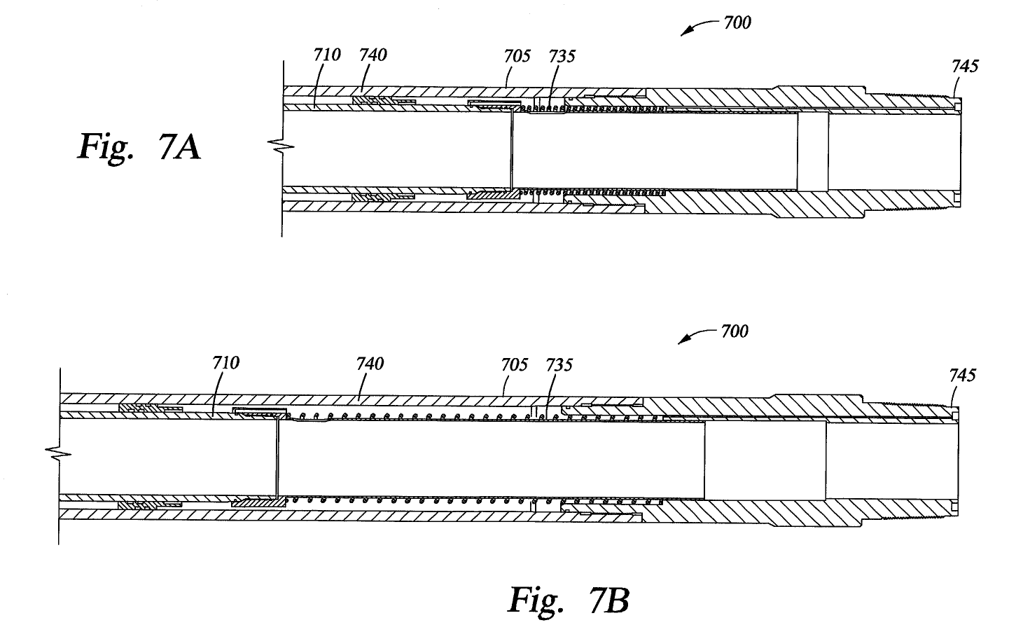

In general, embodiments described in '845 application for allowing communication between components of a downhole tool are shown in FIGS. 7A and 7B. Illustratively, the embodiments are described with respect to a jar. However, the embodiments are applicable to any downhole tool components. FIG. 7A illustrates a jar 700 in a retracted position and FIG. 7B shows the jar in an extended position. The jar 700 includes a coiled spring 735 having a data wire disposed in an interior thereof, running from a first 740 to a second end 745 of the tool 700. The coiled spring and data wire is of a length to compensate for relative axial motion as the tool 700 is operated in a wellbore. In the embodiment of FIGS. 7A and 7B, the coil spring and data wire 735 are disposed around an outer diameter of the mandrel 710 to minimize interference with the bore of the tool 700. In order to install the jar in a drill string, each end of the jar includes an inductive coupling ensuring that a signal reaching the jar from above will be carried through the tool to the drill string and any component therebelow. The induction couplings, because of their design, permit rotation during installation of the tool.

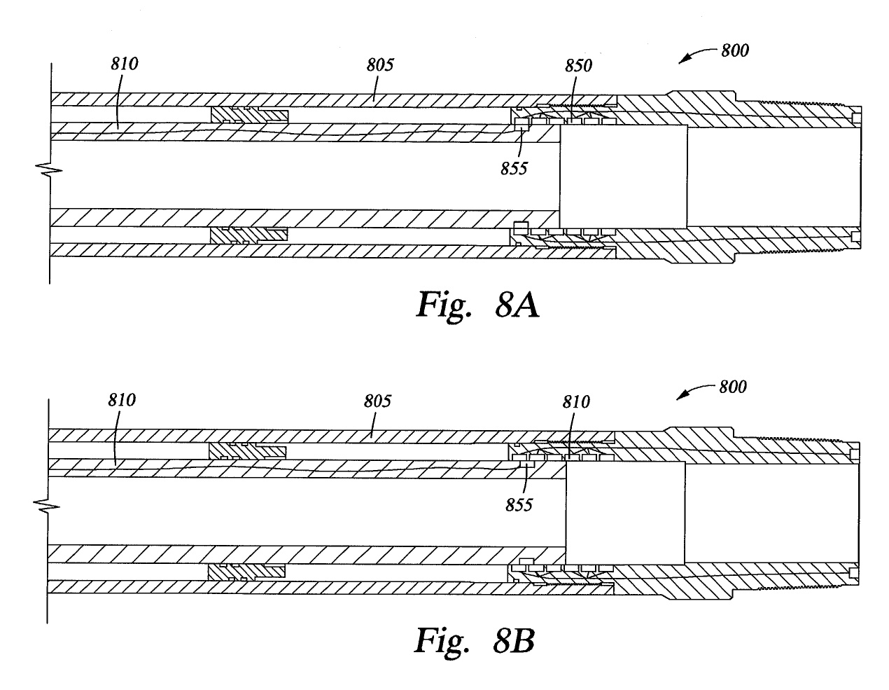

In another embodiment, a series of coils at the end of one of the tool components (e.g., jar components) communicates with a coil in another jar component as the two move axially in relation to each other. FIGS. 8A and 8B show a jar 800 with a housing 805 having a number of radial coils 850 disposed on an inside surface thereof. Each of the coils is powered with a conductor running to one end of the tool 800 where it is attached to drill string. A single coil 855 is formed on an outer surface of a mandrel 810 and is wired to an opposing end of the tool. The coils 850, 855 are constructed and arranged to remain in close proximity to each other as the tool operates and as the mandrel moves axially in relation to the housing.

In FIG. 8A, a single coil 850 is opposite mandrel coil 855. In FIG. 8B, a view of the tool 800 after the mandrel has moved, the coil 855 is partly adjacent two of the coils 850, but close enough for a signal to pass between the housing and the mandrel. In an alternative embodiment, the multiple coils 850 cold be formed on the mandrel and the single coil could be placed on the housing.

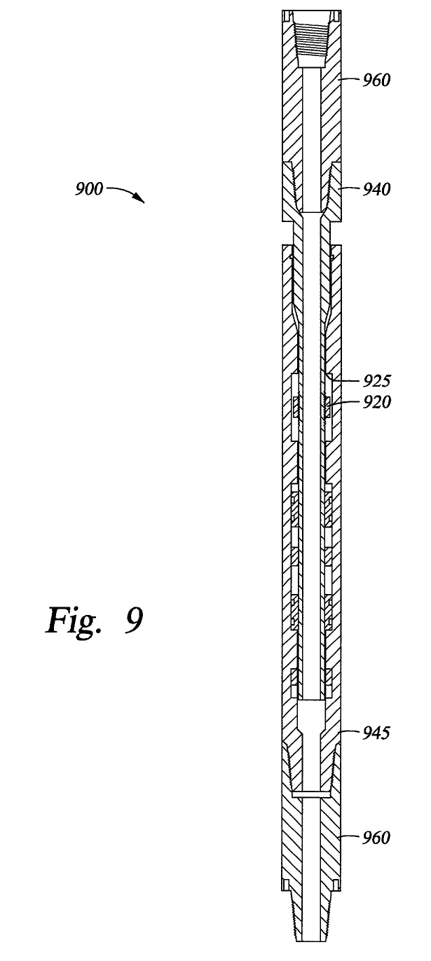

In another embodiment, a signal is transmitted from a first to a second end of the tool through the use of short distance, electromagnetic (EM) technology. FIG. 9 is a section view of a tool 900 (illustratively a jar) with E.M. subs 960 placed above and below the tool 900. The EM subs can be connected to wired drill pipe by induction couplings (not shown) or any other means. The subs can be battery powered and contain all means for wireless transmission, including a microprocessor. Using the E.M. subs 960, data can be transferred around the jar without the need for a wire running through the jar. By using this arrangement, a standard jar can be used without any modification and the relative axial motion between the mandrel and the housing is not a factor. This arrangement could be used for any type of downhole tool to avoid a wire member in a component relying upon relative axial or rotational motion. Also, because of the short transmission distance, the power requirements for the transmitter in the subs 960 is minimal.

In at least some of the embodiments described herein, the information collected downhole by the various measurement devices is transmitted to a remote location external to the downhole tool. In one embodiment, the information is transmitted to a surface node 120 via a network connection 122, as shown in FIG. 1. In general, the surface node 120 may be either a server node or a secondary node located at or near a surface of a borehole. For example, the surface node 120 may be a mud pump controller, in which case the surface node 120 may be characterized as a secondary node. In another embodiment, the surface node 120 may be configured to control the weight on the drill bit 102. In each of the two foregoing embodiments, the surface node 120 receives information from a downhole transmitter (e.g., the transmitter 339). The surface node 120 may then issue appropriate control signals to one or more components of the downhole tool. As such, the downhole tool and the surface node 120 may be characterized as a closed loop in which feedback from the tool is received, processed and responded to (if necessary) by the surface node 120. In another embodiment, the surface node 120 may be a relay configured for long-range transmission (e.g., via satellite). As such, the measurement data may be analyzed and the tool may be controlled and monitored from a remote location (i.e., remote from the tool and the borehole).

While the foregoing is directed to embodiments of the present invention, other and further embodiments of the invention may be devised without departing from the basic scope thereof, and the scope thereof is determined by the claims that follow.

What is claimed is:

1. A method for configuring and communicating between a server node and a plurality of secondary nodes disposed on a modular downhole tool, comprising:
a) detecting, by the server node, the presence of each secondary node; and
b) at least one of:
i) requesting, by the server node, information from at least one of the plurality of secondary nodes; and
ii) issuing a control signal from the server node to at least one of the plurality of secondary nodes;
wherein the server node is disposed on a first module of the modular downhole tool and wherein at least one of the plurality of secondary nodes is disposed on a second module of the modular downhole tool; and wherein the first and second modules are releasably coupled to one another.

2. The method of claim 1, wherein the presence of each secondary node is detected on a transmission medium connecting the server node to the plurality of secondary nodes.

3. The method of claim 1, wherein detecting comprises:
transmitting a wake-up message from the server node to each secondary node; and
receiving an acknowledgement from each secondary node.

4. The method of claim 1, wherein detecting comprises receiving, via the transmission medium, a message from a communications facility of each secondary node.

5. The method of claim 1, wherein the downhole tool further comprises a hub equipped with at least a transmitter and further comprising:
receiving, at the hub, information from the server node; and
transmitting the information to a remote location external to the downhole tool.

6. The method of claim 1, further comprising receiving, at the server node, measurement data collected by one or more of the secondary nodes.

7. The method of claim 6, wherein the measurement data is selected from one of resistivity data, pressure data, radiation data, orientation data and a combination thereof.

8. The method of claim 6, wherein the downhole tool further comprises a hub equipped with at least a transmitter and further comprising:
receiving, at the hub, measurement data from the server node; and
transmitting the measurement data to a remote location external to the downhole tool.

9. The method of claim 8, wherein the measurement data is selected from one of resistivity data, pressure data, radiation data, orientation data and a combination thereof.

10. The method of claim 1, wherein at least a portion of the secondary nodes are equipped with measurement devices and further comprising:
collecting measurement data by the measurement devices; and
transmitting the measurement data to the server node.

11. The method of claim 10, wherein the downhole tool further comprises a hub equipped with at least a transmitter and further comprising:
receiving, at the hub, the measurement data from the server node; and
transmitting the measurement data to a remote location external to the downhole tool.

12. A signal bearing medium containing a program which, when executed by a server node, performs an operation for configuring and communicating between a server node and a plurality of secondary nodes disposed on a modular downhole tool comprising, the operation comprising:
a) detecting, by the server node, the presence of each secondary node; and
b) at least one of:
i) requesting, by the server node, information from at least one of the plurality of secondary nodes; and
ii) issuing a control signal from the server node to at least one of the plurality of secondary nodes.

13. The signal bearing medium of claim 12, wherein the presence of each secondary node is detected on a transmission medium connecting the server node to the plurality of secondary nodes.

14. The signal bearing medium of claim 12, wherein the server node is disposed on a first module of the modular downhole tool and wherein at least one of the plurality of secondary nodes is disposed on a second module of the modular downhole tool; and wherein the first and second modules are releasably coupled to one another.

15. The signal bearing medium of claim 12, further comprising, prior to detecting, transmitting a wake-up message from the server node to each secondary node.

16. The signal bearing medium of claim 12, wherein detecting comprises receiving, via the transmission medium, a message from a communications facility of each secondary node.

17. The signal bearing medium of claim 12, further comprising:
transmitting, from the server node, information received from the secondary nodes to a transmitter configured to transmit the information to a remote location external to the downhole tool.

18. The signal bearing medium of claim 12, further comprising receiving, at the server node, measurement data collected by one or more of the secondary nodes.

19. The signal bearing medium of claim 18, wherein the measurement data is selected from one of resistivity data, pressure data, radiation data, orientation data and a combination thereof.

20. The signal bearing medium of claim 18, further comprising:
transmitting the measurement information from the server node to a transmitter configured to transmit the measurement information to a remote location external to the downhole tool.

21. The signal bearing medium of claim 20, wherein the measurement data is selected from one of resistivity data, pressure data, radiation data, orientation data and a combination thereof.

22. A downhole communications system, comprising:
a server node, comprising:
a) a transceiver configured to communicate with a plurality of secondary nodes; and
b) a controller connected to the transceiver and configured to perform an operation, comprising:
i) detecting the presence of the plurality of secondary nodes; and
ii) at least one of:
requesting, via the transceiver, information from at least one of the plurality of secondary nodes; and
issuing, via the transceiver, a control signal to at least one of the plurality of secondary nodes.

23. The downhole communications system of claim 22, wherein the operation performed by the controller further comprises forwarding, via the transceiver, the information received from at least one of the plurality of secondary nodes to a hub transmitter configured to transmit the information to a remote location external to the downhole communications system.

24. The downhole communications system of claim 22, wherein the transceiver is a wireless transceiver.

25. The downhole communications system of claim 22, wherein the server node and the plurality of secondary nodes are located in different modules of a modular downhole tool.

26. The downhole communications system of claim 23, wherein the modular downhole tool is a drilling tool.

27. The downhole communications system of claim 23, wherein the server node and the plurality of secondary nodes communicate via a physical transmission medium.

28. The downhole communications system of claim 27, wherein the controller is a CAN controller and the physical transmission medium is a CAN bus.

29. The downhole communications system of claim 22, wherein at least a portion of the plurality of secondary nodes comprises a measurement device.

30. The downhole communications system of claim 29, wherein the measurement device comprises logging instruments.

31. The downhole communications system of claim 29, wherein the measurement device is selected from at least one of a gamma radiation measurement device, resistivity measurement device, a pressure measurement device, an orientation measurement device and a combination thereof.

32. A downhole tool, comprising:
at least one secondary downhole tool module equipped with at least a secondary node; and
a server downhole tool module releasably connected to the least one secondary downhole tool module and equipped with at least a server node communicably connected to the secondary node and configured perform an operation, comprising:
a) detecting the presence of the secondary node; and
b) at least one of:
i) requesting information from the secondary node; and
ii) issuing a control signal to the secondary node.

33. The system of claim 29, wherein the server node comprises:
a controller configured to perform the operation; and
a transceiver connected to the controller.

34. The system of claim 33, wherein the controller is a CAN controller.

35. The system of claim 29, wherein the downhole tool is a drilling tool.

36. The system of claim 29, further comprising a transmitter in communication with the server node and configured to transmit information received from the server node to a remote location external to the downhole tool; and wherein the operation performed by the server node further comprises forwarding the information received from the secondary node to the transmitter.

37. The system of claim 29, wherein the at least one secondary downhole tool module comprises a plurality of secondary downhole tool modules each equipped with a respective secondary node.

38. The system of claim 37, wherein at least a portion of the respective secondary nodes comprises a measurement device.

39. The system of claim 38, wherein the measurement device comprises logging instruments.

40. The system of claim 38, wherein the measurement device is selected from at least one of a gamma radiation measurement device, resistivity measurement device, a pressure measurement device, an orientation measurement device and a combination thereof.

41. A method for configuring and communicating between a server node and a plurality of devices disposed on a modular downhole tool, wherein the server node is disposed on a first module of the modular downhole tool and wherein at least one of the plurality of devices is disposed on a second module of the modular downhole tool; and wherein the first and second modules are releasably coupled to one another, the method comprising:
detecting, by the server, the presence of each device; wherein each device is configured for at least one of measuring an environmental parameter and controlling an operation the modular downhole tool; and
transmitting information received from at least one of the plurality of devices to a remote location external to the downhole tool.

42. The method of claim 41, wherein the environmental parameter is selected from one of resistivity, pressure, radiation, orientation and a combination thereof.

43. The method of claim 41, wherein the transmitting is performed by a transmitter connected the server node.

44. The method of claim 41, wherein detecting comprises:
transmitting a wake-up message from the server node to a respective communications facility associated with each device; and
receiving an acknowledgement from each communications facility.
